(19) United States
(12) Patent Application Publication
(10) Pub. No.: US 2013/0013417 A1
(43) Pub. Date: Jan. 10, 2013

(54) OPTIMIZING THE ACQUISITION OF GOODS

(75) Inventors: Michael Hamilton Miller, Pittsburgh, PA (US); Lisa Ann Miller, Pittsburgh, PA (US); James Chia-Ming Liu, Bellevue, WA (US); Alexander George Parakilas, Pittsburgh, PA (US)

(73) Assignee: Ferucia LLC, Seattle, WA (US)

(21) Appl. No.: 13/361,886

(22) Filed: Jan. 30, 2012

Related U.S. Application Data
(60) Provisional application No. 61/438,230, filed on Jan. 31, 2011.

(51) Int. Cl. G06Q 30/02; G06Q 30/00

(52) U.S. Cl. 705/14.66; 705/26.7

(57) ABSTRACT

A facility is provided for adding, identifying, comparing, organizing, annotating, sharing and discovering goods to acquire. This facility provides users with the information and the ability to make informed goods acquisition decisions at the point of sale where they could not have done so previously. Through the system of goods organization, the user will be able to benefit from the identifiable information about the goods that they currently own when presented with new acquirable goods. Knowing the relations between the existing goods owned allows users to benefit from objective measurements of the likelihood of success or satisfaction when presented with a new acquisition target.

### PRIORITY CLAIM

This application claims priority to U.S. Provisional Patent Application No. 61/438,230, entitled “Optimizing the Acquisition of Goods”, which was filed on Jan. 31, 2011, the contents of which are expressly incorporated by reference herein.

### FIELD OF THE INVENTION

The present invention relates to electronic commerce, and more particularly, to systems and methods for optimizing acquisition of goods in e-commerce applications.

### BACKGROUND

Individual shoppers or consumers (users) face a challenge both in person and virtually when they are making purchasing decisions. Goods, such as apparel, movies, food, and books pose a significant problem. Consumers can acquire many more goods than they are able to accurately or efficiently keep track of or organize while making a purchasing decision. When the goods are individual apparel items, ones that are mixed together and used at the same time to form a look or style, the challenge becomes even more complex. In order to make the best acquisition decisions, consumers must keep track of what they own and how the things that they own can be combined with the new items they acquire. When faced with this complex task, consumers can either pre-organize and commit to memory what they own or pursue trial and error by acquiring the goods, matching them and then returning them until they make satisfactory matches.

The inefficient and ineffective systems that users employ to avoid the process being merely that of a system of trial and error are numerous. Consumers attempt to take photos of the goods, they create lists of the goods, they copy goods arrangements submitted by professionals, and they use the equally fallible opinions or memories of their friends. These supplements to the trial and error process lead to continued dissatisfaction of items acquired leading to returns, disposal, or even worse additional confusion and frustration.

The foregoing examples of the related art and limitations related therewith are intended to be illustrative and not exclusive. Other limitations of the related art will become apparent upon a reading of the specification and a study of the drawings.

### SUMMARY

A facility is provided for adding, identifying, comparing, organizing, annotating, sharing and discovering goods to acquire. This facility provides users with the information and the ability to make informed goods acquisition decisions at the point of sale where they could not have done so previously. Through the system of goods organization, the user will be able to benefit from the identifiable information about the goods that they currently own when presented with new acquirable goods. Knowing the relations between the existing goods owned allows users to benefit from objective measurements of the likelihood of success or satisfaction when presented with a new acquisition target.

Because the facility organizes the goods that the consumer owns, the facility can also help the consumer with the process of goods discovery. Previously unknown preferences that the user has can be identified and users will not have to rely on their interest being peaked to find goods that present ideal acquisition candidates.

In one embodiment, a computer implemented method for recommending a target item is provided. The method comprises steps of: receiving an identification information for the target item; locating the target item in an item database using the identification information, the item database containing metadata of the target item; comparing the metadata of the target item to metadata of a profile, the profile comprising metadata of a plurality of items located in the item database; calculating a confidence measurement, the confidence measurement quantizing an overlap between the metadata of the target item and the metadata of the profile; and contacting a user associated with the profile about the target item if the confidence measurement exceeds a pre-determined value.

In another embodiment, a computer implemented method for finding items similar to a target item is provided. The method comprises steps of: receiving an identification information for the target item; locating the target item in an item database using the identification information, the item database containing metadata of the target item; comparing the metadata of the target item to metadata of a plurality of items in the item database; calculating a similarity measurement for each of the plurality of items, each similarity measurement quantizing an overlap between the metadata of the target item and the metadata of the corresponding item of the plurality of items; and recommending to a user one or more items that have similarity measurements exceeding a pre-determined value.

In yet another embodiment, a computer implemented method for finding items pair with a target item is provided. The method comprises steps of: receiving an identification information for the target item; locating the target item in an item database using the identification information, the item database containing metadata of the target item; comparing the metadata of the target item to metadata of a plurality of items in the item database; calculating a pairing measurement for each of the plurality of items, each pairing measurement quantizing how well the target item pairs with the corresponding item of the plurality of items, based on the metadata of the target item and the corresponding item; and recommending to a user one or more items that have pairing measurements exceeding a pre-determined value.

This Summary is provided to introduce a selection of concepts in a simplified form that are further described below in the Detailed Description. This Summary is not intended to identify key features or essential features of the claimed subject matter, not is it intended to be used to limit the scope of the claimed subject matter.

### BRIEF DESCRIPTION OF THE DRAWINGS

One or more embodiments of the present invention are illustrated by way of example and are not limited by the figures of the accompanying drawings, in which like references indicate similar elements.

FIG. 1 is a diagram illustrating an example of a suitable computing environment in which the facility may operate.

FIG. 2 is a flow diagram illustrating the profiling routine invoked by the facility in some embodiments.

FIG. 3 is a flow diagram illustrating the cataloging routine invoked by the facility in some embodiments.

FIG. 4 is a flow diagram illustrating the discovery routine invoked by the facility in some embodiments.

FIG. 5 is a flow diagram illustrating the targeting routine invoked by the facility in some embodiments.

FIG. 6 is a flow diagram illustrating the pairing routine invoked by the facility in some embodiments.

FIG. 7 is a block diagram of a processing system that can be used to implement an facility implementing the techniques described herein.

### DETAILED DESCRIPTION

Various aspects of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description. Although the diagrams depict components as functionally separate, such depiction is merely for illustrative purposes. It will be apparent to those skilled in the art that the components portrayed in this figure may be arbitrarily combined or divided into separate components.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

References in this specification to “an embodiment,” “one embodiment,” or the like mean that the particular feature, structure, or characteristic being described is included in at least one embodiment of the present invention. Occurrences of such phrases in this specification do not necessarily all refer to the same embodiment.

A facility is provided for adding, identifying, comparing, organizing, annotating, sharing and discovering goods to acquire. The facility is based upon dynamic collections of item metadata stored in databases accessible through multiple internet access points including but not limited to mobile. This item metadata is accessed by the user through an efficient item lookup procedure. For example this look up is completed through a number of options including the process of obtaining a near field communication (NFC) tag, a RFID, an audio message, a product's Universal Product Code, QR code or other barcode through a mobile bar code scanner or near field communications scanner. In one embodiment, the scanner may have a visual sensor such as a camera to read the code or tag. The product's model number, name or image can be also used to locate the item. Once the item is either located in the database or a generic metadata item representation is selected by the user, the user has many options including creating, using or sharing a profile which is a collection of items metadata, or engaging in other metadata comparison procedures that aid the user with informed decision making tasks at the point of sale. Tasks include but are not limited to size comparison, promotions, ratings, sharing and consistency with a profile. Because item data is stored in the cloud and accessible through mobile or other web based access methods, the user can access their information in multiple shopping mediums including in physical and online stores, shops or websites.

The facility also allows users to keep track of the items that they own or would like to purchase in the future through the use of lists. The lists may be sorted and manipulated. These lists allow users to avoid purchasing duplicate items and they allow other users to identify users they know to be interested in purchasing specific items with targeted promotions to facilitate acquisition.

Thus the facility is enabling users to optimize their acquisition of items through the use of profiles which facilitate metadata comparison that would otherwise be subject to inadequate or inaccurate completion. Doing so removes the difficulty users have in identifying items that they will be satisfied with purchasing.

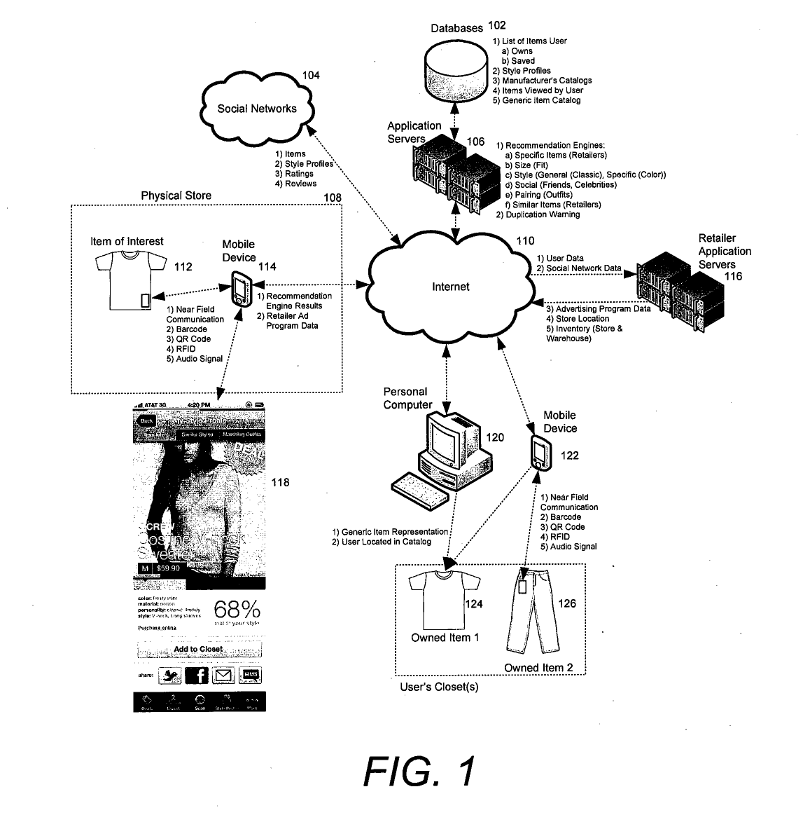

Turning now to the figures, FIG. 1 is a diagram illustrating an example of a suitable computing environment in which the facility may be implemented. A system for implementing the facility includes a general purpose or special purpose computing systems or configurations. Examples of well-known computing systems, environments, and/or configurations that may be suitable for use with the facility include, but are not limited to, personal computers, server computers, handheld or laptop devices, cellular/mobile telephones, tablet devices, multiprocessor systems, microprocessor-based systems, set-top boxes, network capable television, game console, programmable consumer electronics, network PCs, minicomputers, mainframe computers, distributed computing environments that include any of the above systems or devices, and the like.

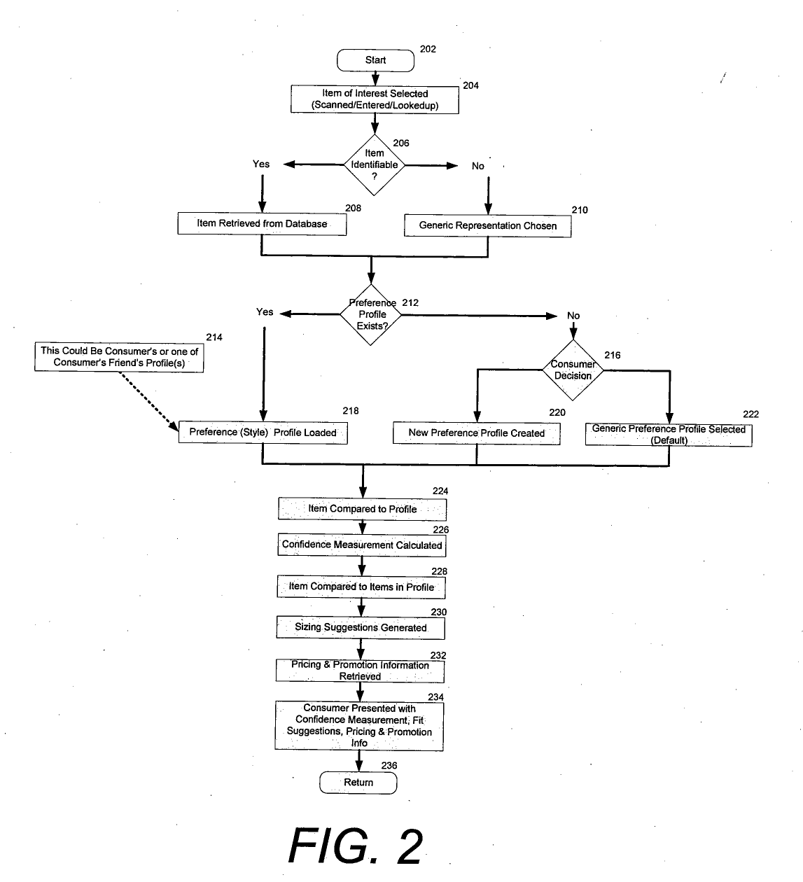

FIG. 2 is a flow diagram illustrating the profiling routine invoked by the facility in some embodiments. The facility allows a user to find an item of interest in a database in an efficient manner by either scanning, entering or looking up the item using a variety of methods. If this item is located in the database then the item will have metadata, which is structured information that describes or explains the item, pre-populated and associated with the item. If the item is not located in the database, the user can find a generic representation of the item of interest with a similar set of subsequent metadata to represent the item entered. The user can then take that item and its associated metadata, and perform a number of higher level assignments, associations or comparisons to profiles. A profile is a collection of database items, where the metadata of all the items in the profile are used to define the profile. The user can then associate a friendly name with the profile to facilitate more natural interaction with the system making it more efficient and effective. Users can then publish or share their profiles and use profiles to do metadata comparisons. These metadata comparisons in the context of looking up apparel item would enable sizing recommendations, and the opportunity for price or promotional information to be shared with the user. By comparing profile metadata across many profiles created by multiple users, insights into item attributes that may otherwise not be apparent to a user will become apparent. As an example if apparel items were to be compared between multiple manufactures, a size medium could be identified through the use of metadata comparison to translate to a size large in another manufacturer's item. This in turn builds user confidence in using the system as the facility is enabling the user to make purchasing decisions with confidence. As another example, if an apparel item were selected to be compared against a profile representing a certain fashion style or look, then the profile's respective metadata from the items associated with that profile would enable a user to determine if the item of interest has metadata that produces a good match to that fashion style profile or not. In one embodiment, the metadata of a target item may include, but not limited to, size information, manufacture information, customer rating information, fashion style information, color information, fit information such as regular fit or slim fit, and/or season information.

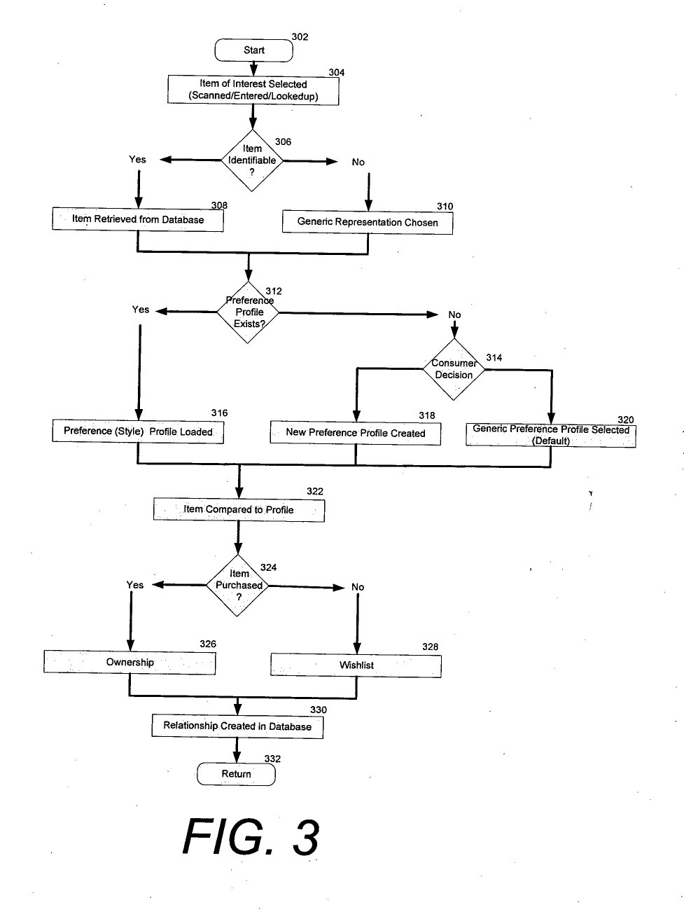

FIG. 3 is a flow diagram illustrating the cataloging routine invoked by the facility in some embodiments. The facility, in various embodiments, can allow a user to save the item associated with a profile as in FIG. 2 to multiple lists associated with various states associated with item ownership. For example, after an item is compared with a profile, it can be saved to a list indicating ownership. This then would allow a scan of an item in the future to indicate if the item is already owned by comparison with this list, or it would allow a metadata comparison with a future item of interest to indicate to the user that the item is highly similar to an item already owned. In this way duplicate item acquisition could be prevented or encouraged through the use of this list. As a further example of lists, a user could also after comparison, save the item to a wishlist to aide them in remembering the item of interest for the future after comparison against a profile. This improves the user's ability to shop by keeping a list of items to acquire for the user in a centralized location in the routine associated with item comparison with profiles.

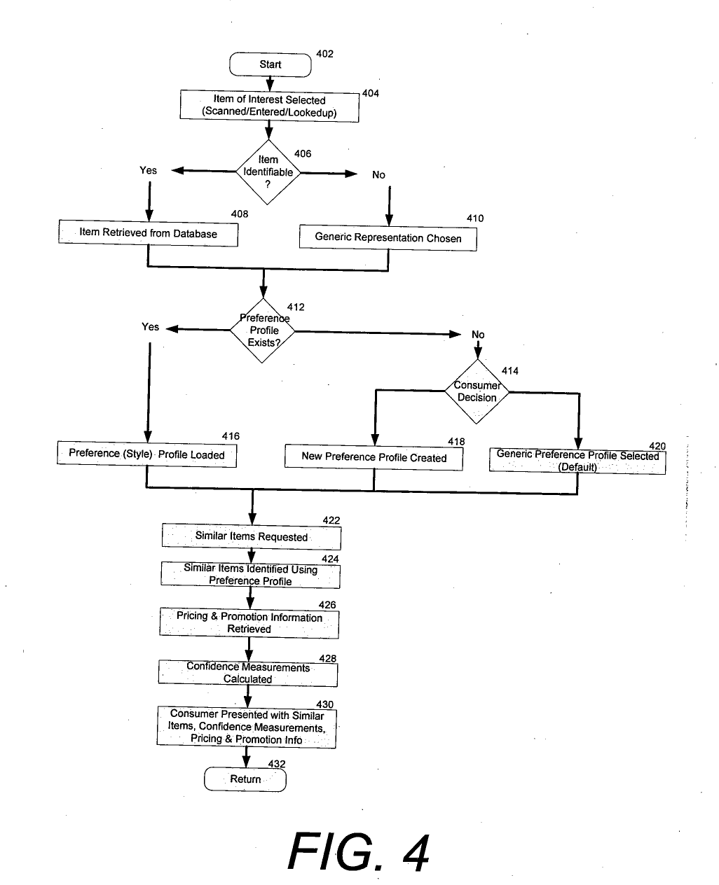

FIG. 4 is a flow diagram illustrating the discovery routine invoked by the facility in some embodiments. The facility, in various embodiments, can allow a user to request items that are similar to the one that they have scanned known to the system. After the item's metadata is retrieved by the system, the user can request similar items to be returned for the user to review. This helps the user's ability to discover similar items of interest that may otherwise require extensive effort to compare. For example, a user may scan one apparel item at a store and like it, but would also like to know what other items are available from other manufacturers or retailers. By using the facility, the other manufacturer's items in the system's database can be pulled up by the facility based on their metadata comparison with the item of interest and presented to the user. These items can then be compared against profiles in the way any item can be with this system. In one embodiment, a similarity measurement is calculated, the similarity measurement quantizing an overlap between the metadata of the target item and the metadata of the candidate item.

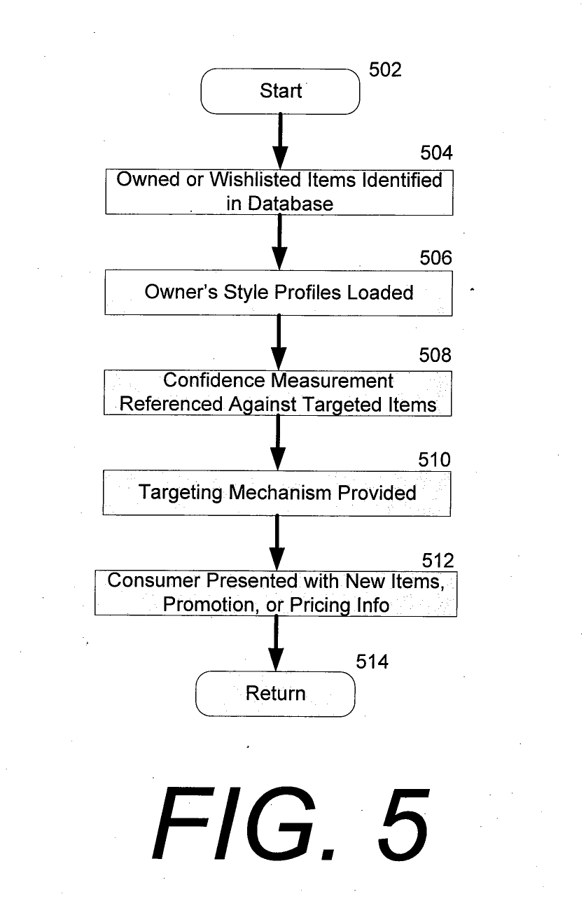

FIG. 5 is a flow diagram illustrating the targeting routine invoked by the facility in some embodiments. The facility, in various embodiments, can allow users to identify items on a user's lists and then target the user with promotions or other communications or confidence information based on profile comparisons. For example, a user's wishlist could be scanned by the facility to identify items that are on sale. These items could be compared against a profile, a confidence measurement could be calculated based upon the item's metadata overlap with the profile's metadata definition. An email could then be generated presenting the user with a promotion for the item with an associated confidence measurement. This provides the user of the targeting mechanism the ability to know the item that the individual is interested in, how well if fits with their profile and offer them a promotion.

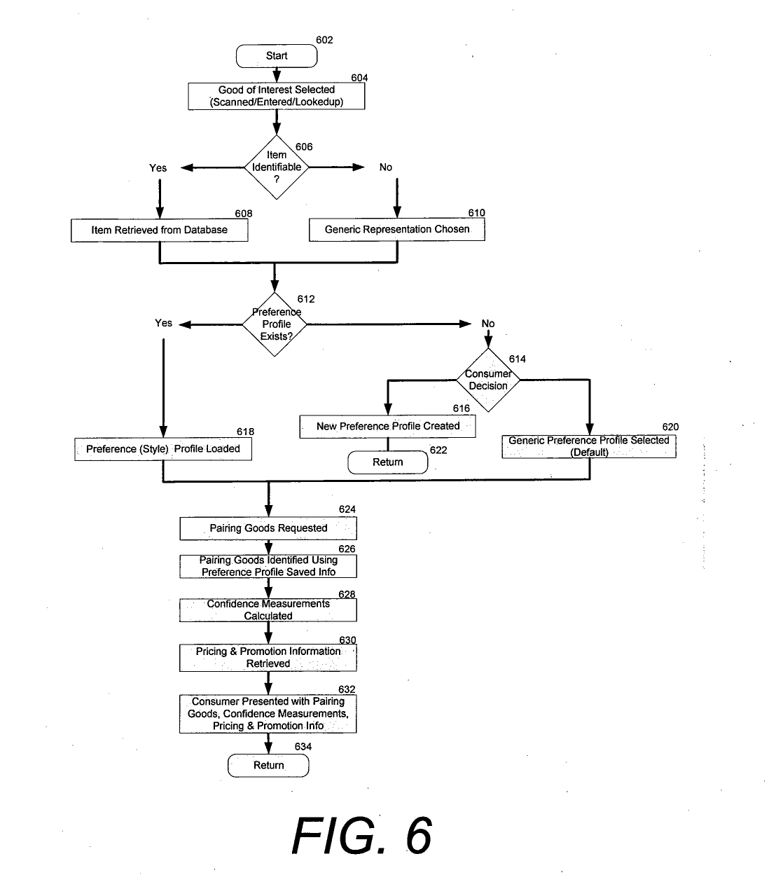

FIG. 6 is a flow diagram illustrating the pairing routine invoked by the facility in some embodiments. The facility, in various embodiments, can allow users to request items that pair with the one that they have scanned that are known to the system. Pairing information may be added into the facility by the user, or automatically by the facility. After the item's metadata is retrieved by the system, the user can request items that match or pair well with the user to review. This helps the user's ability to pair items of interest that may otherwise require extensive effort to pair. For example, a user may scan one apparel item at a store and like it, but want to know what other items they own, or are for sale from other manufacturer's that pair well with their item of interest. By using the facility, the other items known to the system can be pulled up by the facility based on their metadata comparison with the item of interests and presented to the user. These items can then be compared against profiles in the way any item can be with this system. In one embodiment, a pairing measurement is calculated for each of the plurality of items, each pairing measurement quantizing how well the target item pairs with the corresponding item of the plurality of items, based on the metadata of the target item and the corresponding item. One or more items that have pairing measurements exceeding a pre-determined value is recommended to a user.

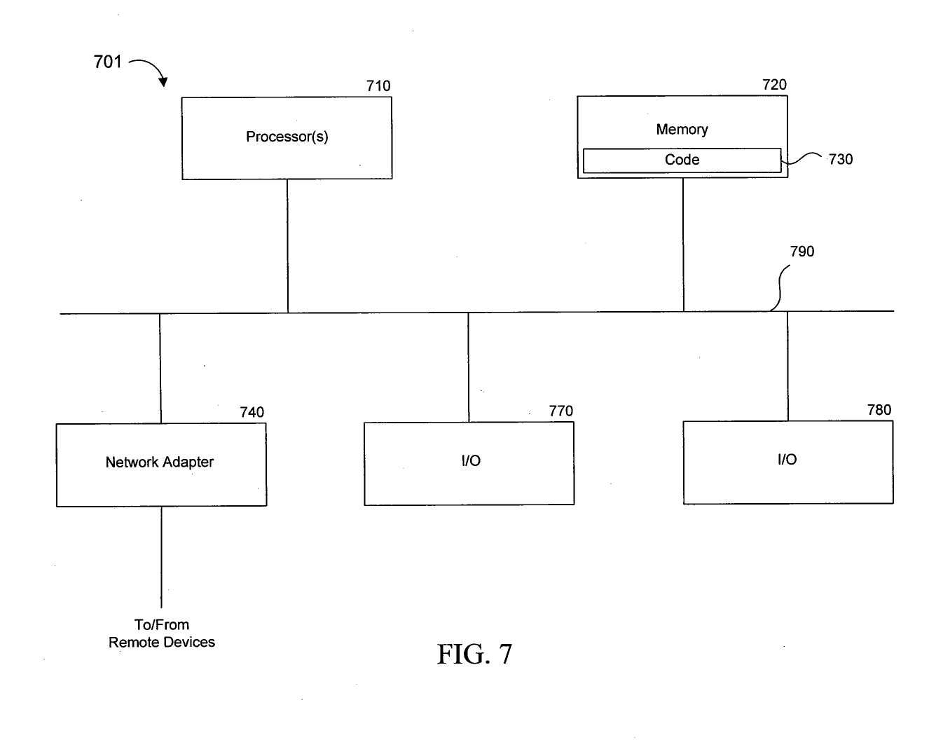

FIG. 7 is a block diagram of a processing system that can be used to implement any of the techniques described above, such as the facility. Note that in certain embodiments, at least some of the components illustrated in FIG. 7 may be distributed between two or more physically separate but connected computing platforms or boxes. The processing can represent a conventional server-class computer, PC, mobile communication device (e.g., smartphone), or any other known or conventional processing/communication device.

The processing system 701 shown in FIG. 7 includes one or more processors 710, i.e. a central processing unit (CPU), memory 720, at least one communication device 740 such as an Ethernet adapter and/or wireless communication subsystem (e.g., cellular, WiFi, Bluetooth or the like), and one or more I/O devices 770, 780, all coupled to each other through an interconnect 790.

The processor(s) 710 control(s) the operation of the computer system 701 and may be or include one or more programmable general-purpose or special-purpose microprocessors, microcontrollers, application specific integrated circuits (ASICs), programmable logic devices (PLDs), or a combination of such devices. The interconnect 790 can include one or more buses, direct connections and/or other types of physical connections, and may include various bridges, controllers and/or adapters such as are well-known in the art. The interconnect 790 further may include a “system bus”, which may be connected through one or more adapters to one or more expansion buses, such as a form of Peripheral Component Interconnect (PCI) bus, HyperTransport or industry standard architecture (ISA) bus, small computer system interface (SCSI) bus, universal serial bus (USB), or Institute of Electrical and Electronics Engineers (IEEE) standard 1394 bus (sometimes referred to as “Firewire”).

The memory 720 may be or include one or more memory devices of one or more types, such as read-only memory (ROM), random access memory (RAM), flash memory, disk drives, etc. The network adapter 740 is a device suitable for enabling the processing system 701 to communicate data with a remote processing system over a communication link, and may be, for example, a conventional telephone modem, a wireless modem, a Digital Subscriber Line (DSL) modem, a cable modem, a radio transceiver, a satellite transceiver, an Ethernet adapter, or the like. The I/O devices 770, 780 may include, for example, one or more devices such as: a pointing device such as a mouse, trackball, joystick, touchpad, or the like; a keyboard; a microphone with speech recognition interface; audio speakers; a display device; etc. Note, however, that such I/O devices may be unnecessary in a system that operates exclusively as a server and provides no direct user interface, as is the case with the server in at least some embodiments. Other variations upon the illustrated set of components can be implemented in a manner consistent with the invention.

Software and/or firmware 730 to program the processor(s) 710 to carry out actions described above may be stored in memory 720. In certain embodiments, such software or firmware may be initially provided to the computer system 701 by downloading it from a remote system through the computer system 701 (e.g., via network adapter 740).

The techniques introduced above can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

The teachings of the invention provided herein can be applied to other systems, not necessarily the system described above. The elements and acts of the various embodiments described above can be combined to provide further embodiments.

While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

What is claimed is:

1. A computer implemented method for recommending a target item, the method comprising:
receiving an identification information for the target item;
locating the target item in an item database using the identification information, the item database containing metadata of the target item;
comparing the metadata of the target item to metadata of a profile, the profile comprising metadata of a plurality of items located in the item database;
calculating a confidence measurement, the confidence measurement quantizing an overlap between the metadata of the target item and the metadata of the profile; and
contacting a user associated with the profile about the target item if the confidence measurement exceeds a pre-determined value.

2. The method as recited in claim 1, further comprising:
saving the target item in a ownership list of the user if the user has purchased the target item.

3. The method as recited in claim 1, further comprising:
avoiding contacting the user about the target item if the target item is in a ownership list of the user.

4. The method as recited in claim 1, further comprising:
receiving a feedback from the user for wishing the target item
saving the target item in a wish list of the user.

5. The method as recited in claim 1, wherein the step of comparing comprises comparing the metadata of the target item to metadata of a plurality of profiles, and the step of calculating comprises calculating a plurality of confidence measurements, each confidence measurement quantizing an overlap between the metadata of the target item and the metadata of a profile from the plurality of profiles.

6. The method as recited in claim 1, wherein the step of contacting comprises:
contacting a user associated with the profile about how well the target item fits with the profile based on the confidence measurement if the confidence measurement exceeds a pre-determined value.

7. The method as recited in claim 1, wherein the target item is on promotion and the step of contacting comprises contacting a user associated with the profile about the promotion if the confidence measurement exceeds a pre-determined value.

8. The method as recited in claim 1, wherein at least one item in the item database is a piece of apparel.

9. The method as recited in claim 1, wherein the metadata of the target item includes one or more of:
size information;
manufacture information;
customer rating information;
fashion style information;
color information;
fit information; or
season information.

10. The method as recited in claim 1, further comprising:
publishing the profile so that other users can access the profile.

11. The method as recited in claim 1, further comprising:
naming the profile.

12. The method as recited in claim 1, wherein the identification information for the target item includes one or more of:
universal product code;
QR Code;
a barcode;
a NFC tag;
a RFID;
product model number;
product name; or
image of the target item.

13. The method as recited in claim 1, wherein the identification information for the target item is captured by a mobile phone.

14. The method as recited in claim 1, wherein the step of contacting comprises contacting a user associated with the profile about the target item if the confidence measurement exceeds a pre-determined value via devices including one or more of:
personal computer;
server computer;
laptop computer;
mobile phone;
tablet computer;
set-top boxes;
game console; or
network capable television.

15. A computer implemented method for finding items similar to a target item, the method comprising:
receiving an identification information for the target item;
locating the target item in an item database using the identification information, the item database containing metadata of the target item;
comparing the metadata of the target item to metadata of a plurality of items in the item database;
calculating a similarity measurement for each of the plurality of items, each similarity measurement quantizing an overlap between the metadata of the target item and the metadata of the corresponding item of the plurality of items; and
recommending to a user one or more items that have similarity measurements exceeding a pre-determined value.

16. The method as recited in claim 15, wherein the identification information for the target item includes one or more of:
universal product code;
QR Code;
a barcode;
a NFC tag;
a RFID;
product model number;
product name; or
image of the target item.

17. A computer implemented method for finding items pair with a target item, the method comprising:
receiving an identification information for the target item;
locating the target item in an item database using the identification information, the item database containing metadata of the target item;
comparing the metadata of the target item to metadata of a plurality of items in the item database;
calculating a pairing measurement for each of the plurality of items, each pairing measurement quantizing how well the target item pairs with the corresponding item of the plurality of items, based on the metadata of the target item and the corresponding item; and
recommending to a user one or more items that have pairing measurements exceeding a pre-determined value.

18. The method as recited in claim 17, wherein at least one item of the plurality of items is on a wish list of the user.

19. The method as recited in claim 17, wherein at least one item of the plurality of items is owned by the user.

20. The method as recited in claim 17, wherein the identification information for the target item includes one or more of:
universal product code;
QR Code;
a barcode;
a NFC tag;
a RFID;
product model number;
product name; or
image of the target item.
